(19) United States
(12) Patent Application Publication
(10) Pub. No.: US 2006/0167773 A1
(43) Pub. Date: Jul. 27, 2006

(54) Settlement of auctions by determining quantity before price

(76) Inventors: Kangle Yang, Taixing (CN); Kevin Ka-Shun Fung, Hong Kong (HK); Daniel Ming-Chiu Chan, Hong Kong (HK); Michael Kwok-Po Ng, Hong Kong (HK)

Correspondence Address: FENWICK & WEST LLP, SILICON VALLEY CENTER, 801 CALIFORNIA STREET, MOUNTAIN VIEW, CA, 94041, US

(21) Appl. No.: 10/953,810

(22) Filed: Sep. 28, 2004

Related U.S. Application Data
(63) Continuation-in-part of application No. 10/813,216, filed on Mar. 29, 2004.
(60) Provisional application No. 60/529,563, filed on Dec. 16, 2003.
(60) Provisional application No. 60/518,636, filed on Nov. 12, 2003.
(60) Provisional application No. 60/573,940, filed on May 25, 2004.

(51) Int. Cl. G06Q 40/00

(52) U.S. Cl. 705/35

(57) ABSTRACT

The orders collected during an auction form an auction pool. The fill for orders in the auction pool is established without setting an auction settlement price (ASP) for the contracts in the auction pool. The ASPs for contracts in the qualified pool are then set based on the fill. Both the process for establishing the fill for orders and/or the process for setting the ASPs preferably are based on LP and/or QP optimizations.

### CROSS-REFERENCE TO RELATED APPLICATION

This application (a) is a continuation-in-part of U.S. patent application Ser. No. 10/813,216, “Settlement of Auctions by Determining Quantity before Price,” filed Mar. 29, 2004; which claims priority under 35 U.S.C. § 119(e) to U.S. Provisional Patent Application Ser. No. 60/529,563, “Risk Management for Options & Others,” filed Dec. 16, 2003; (b) claims priority under 35 U.S.C. § 119(e) to U.S. Provisional Patent Application Ser. No. 60/518,636, “New Design for Pool Operators,” filed Nov. 12, 2003 by Kevin K. S. Fung; and (c) claims priority under 35 U.S.C. § 119(e) to U.S. Provisional Patent Application Ser. No. 60/573,940, “Auction Method for Event Risk Management,” filed May 25, 2004 by Kangle Yang, Daniel M. C. Chan and Kevin K. S. Fung.

### BACKGROUND OF THE INVENTION

1. Field of the Invention

This invention relates generally to the settlement of auctions.

2. Description of the Related Art

A variety of financial instruments, which shall be referred to generally as contracts, are currently traded in many different markets. These contracts can take a variety of forms and can be related to a variety of activities or events. For example, the contracts could range from options and futures to betting. Participants in the markets typically make offers to buy contract(s) (also known as bids) and/or offers to sell contract(s) (also known as offers). Each bid and offer typically has a price limit associated with it. The participants in the market could include individual participants, financial intermediaries, and/or market makers, such as brokerage houses or banks.

Furthermore, the buyers and sellers can be either short or long. For example, a long seller is a seller already having a position in the market and holding the contract for which the seller makes an offer. A short seller is a seller who does not yet have ownership of the contract being offered for short sale. Similarly, a buyer may be making a bid to cover a contract previously offered for sale.

Typically, the interaction between the market participants can take place via three conventional structures: conventional order matching, conventional market making, and conventional auctions. In conventional order matching, offers to buy and sell are centralized, typically in an exchange, and orders are filled by matching them with the complementary order. Individual participants can then buy or sell until an equilibrium for a particular contract is reached. Typically, the exchange takes no risk in the market. In conventional market making, a market maker takes a position opposite to other market participants. Thus, a market maker may sell or buy contracts to other market participants.

In conventional auctions, a contract is typically offered for sale to any market participant. Conventional auctions can take a variety of forms. In certain conventional auctions, the contract is initially offered at a high price. The price is progressively lowered until a bid is made and the contract is sold. In conventional Dutch auctions, offers to buy are accumulated and the lowest price necessary to sell the entire lot of contracts becomes the price at which the contracts are sold. Mutualized risk pools can also be considered a form of auction. In a mutualized risk pool, market participants can choose to put money into a pool up until a cutoff time. When the pool closes, the money placed into the pool determines the prices of the contracts.

The relationships between buyers, sellers, and those who facilitate the market (e.g., market makers, exchanges, auction organizers, etc.) can be complex. For example, in the case of betting, individuals are usually limited to the role of making bets (i.e., purchasing contracts) and the role of selling contracts is the province of the bookmaker. Furthermore, unnecessary uncertainty may be created in these relationships, which indirectly increases trading costs.

Although conventional structures allow transactions to take place and for the market to come to equilibrium, conventional structures also have drawbacks. For example, conventional structures may not result in a high degree of liquidity. Generally speaking, high liquidity is desirable. A higher liquidity allows the market participants to move in and out of the market more easily. In addition, exchanges desire a high liquidity because exchanges typically obtain a profit based upon the number of transactions carried out. Higher liquidity usually translates into a higher number of transactions and therefore a greater profit for the exchange. Market makers desire a higher liquidity because a high liquidity translates to a higher number of transactions, lower risk for the market maker and a lower cost of borrowing capital for the market maker. Thus, it is desirable for a higher liquidity in the market place than may be available using the conventional structures.

Conventional order matching, market making and auctions also have other drawbacks. Conventional order matching often does not function well when there is an insufficient number of sellers that actually have contract(s) to sell, as opposed to a short seller. For example, there may be a disproportionate number of buyers without matching sellers. As a result, there will be lowered liquidity. In some situations, conventional market makers may actually have an incentive to reduce the competitive nature of the marketplace because the market maker may act to their own advantage, rather than to the advantage of the market as a whole. Conventional auctions can take time to organize and identify the winner(s) and, in the absence of sufficient offers, can fail to facilitate trading.

Moreover, conventional auctions generally can only be used in trading of single products but not related products. An example would be the Dutch auction where a single product of a fixed quantity is being sold, and the price of the lowest qualifying bid would be used as the price. As it stands, the Dutch auction cannot be applied to trading of financial products based on a continuous variable (e.g., an underlying stock price).

Accordingly, there is a need for mechanisms that increase the liquidity of markets and/or address the drawbacks of conventional auctions.

### SUMMARY OF THE INVENTION

One aspect of the present invention overcomes the limitations of the prior art by settling an auction of contracts as follows. The orders collected during the auction form an auction pool. The fill for orders in the auction pool is established without setting an auction settlement price (ASP) for the contracts in the auction pool. The fill determines a qualified pool of orders and an unqualified pool. The ASPs for contracts in the qualified pool are set based on the fill. Both the process for establishing the fill for orders and the process for setting the ASPs preferably are based on LP and/or QP optimizations. This can increase the speed of these processes.

In one aspect of the invention, the fill is established according to price aggressiveness of the orders. For example, LP optimization can be used to maximize an aggregate price aggressiveness subject to constraints defined in the orders (e.g., quantity limits) and subject to the requirement that filled orders form complete sets (as further described below). Dummy zero fill orders can also be used to maximize price aggressiveness, as explained in further detail below. For orders of the same price aggressiveness, the fill can be determined according to other priority factors, such as a time chop.

In another aspect of the invention, the ASPs are set by first determining a lower price bound and an upper price bound for contracts, according to price constraints defined in the orders and further according to the fill for the orders. The ASPs are selected to fall within the range defined by the lower and upper price bounds. The price bounds can be selected in a number of ways. For example, the price gap between the lower and upper price bounds can be maximized, the variance of the price bounds from some other price figure can be minimized and/or the price constraints can be taken from only qualified orders, only unqualified orders, or a combination of qualified and unqualified orders. Similarly, different methods can be used to select the ASPs within the price range. Different types of interpolation, including linear interpolation, can be used.

In yet another aspect of the invention, orders for “native” contracts are expressed in terms of a special set of contracts, which shall be referred to as basic units. The native contracts are expressed as combination orders of the basic units and the auction is settled based on the combination orders. The auction can be settled using the methods described above or other settlement methods can be used instead. The set of basic units preferably is mutually exclusive and collectively exhaustive, can form complete sets in only one way, and is efficient with respect to the set of native contracts.

In one specific application, the orders for “native” contracts are a pool of bets, for example based on the outcome of a race or the scoring in a competition between two teams/individuals. In one approach, the set of basic units are discrete contracts corresponding to different possible outcomes or scores, but all with the same notional. In another example application, the orders for native contracts include orders for vanilla options. In one approach, the set of basic units includes diverging slope and/or converging slope basic units that approximate the unbounded portion of the vanilla options.

Other aspects of the invention include different variations to address different types of contracts, and devices and systems corresponding to all of the above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 (prior art) is a table showing different types of contracts.

FIGS. 2A-2E are payoff diagrams illustrating different complete sets of contracts.

FIGS. 3-4 are payoff diagrams illustrating different sets of basic units.

FIGS. 5A-5C are payoff diagrams illustrating the decomposition of a call spread into basic units.

FIG. 6 is a timeline of an auction according to the invention.

FIG. 7 is a flow diagram showing various methods for settling an auction according to the invention.

FIG. 8 is a flow diagram showing one method for establishing the fill.

FIG. 9 is a flow diagram showing one method for setting the auction settlement price.

FIG. 10 is a diagram illustrating the fill for a numerical example.

FIG. 11 is a block diagram of a computer system suitable for use with the present invention.

FIG. 12 is a table illustrating a set of basic units suitable for horse racing.

FIG. 13 is a table illustrating a set of basic units suitable for football matches.

FIGS. 14A-14F are tables illustrating the expression of different types of football native bets as combinations of basic units.

FIG. 15 is a payoff diagram illustrating a set of basic units for use with vanilla options.

FIGS. 16A-16C are payoff diagrams illustrating the decomposition of different types of orders using the set of basic units shown in FIG. 15.

### DETAILED DESCRIPTION OF THE PREFERRED EMBODIMENTS

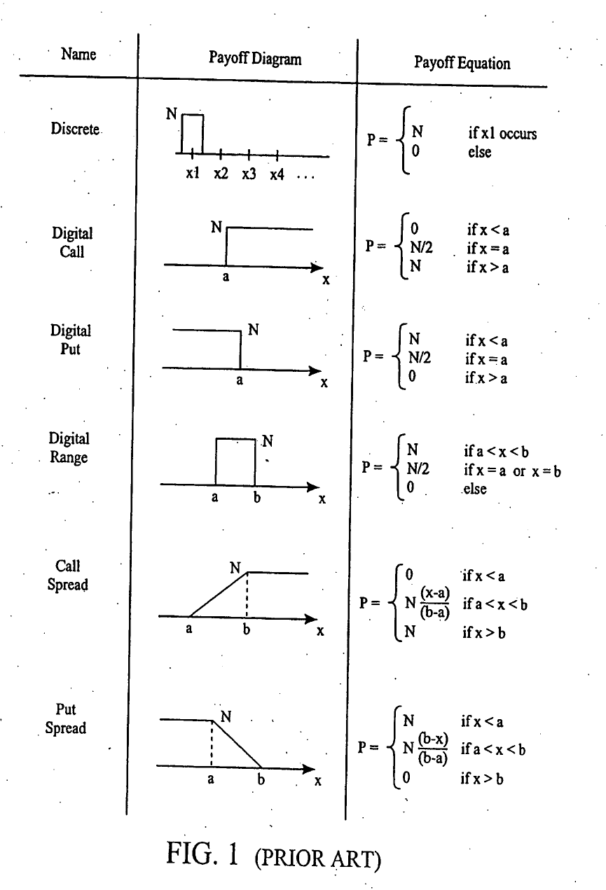

This invention relates generally to buying and selling contracts, particularly in the context of auctions. It is useful to begin with some underlying concepts, as illustrated in FIGS. 1-5.

FIG. 1 is a table showing the following types of contracts: discrete, digital call, digital put, digital range, call spread and put spread. These examples are selected for illustrative purposes; the invention is not limited to these contracts. In the table, the payoff diagram describes the payoff of a contract. The x-axis in the payoff diagram is the underlying event (or state) upon which the contract depends and the y-axis is the payoff. The payoff equation is a mathematical description of the payoff. The payoff function for a contract Cx shall be denoted as P(Cx). The columns “Payoff Diagram” and “Payoff Equation” are graphical and mathematical representations of P(Cx) for the specific contracts shown.

Some general remarks can be made about these contracts. First, note that the underlying event can be modeled as either discrete or continuous. It is discrete for the discrete contract and continuous for the other examples. The event can be modeled as discrete if there are a relatively small, finite number of possible outcomes. In the table, the possible outcome states are denoted as x1, x2, etc. It is more appropriately modeled as continuous if it is continuous or there are a large enough number of possible outcomes that it can be effectively modeled as continuous. In the table, the payoffs for the continuous cases depend on the value of state x. Note that events can be modeled as either discrete or continuous, depending on the content of the contract. In addition, the underlying events can be multi-dimensional, not just one-dimensional as shown in the table.

One example of a discrete event is a horse race, where the possible outcomes are x1: horse 1 wins, x2: horse 2 wins, etc. Another example is a sporting event where the possible outcomes are x1: Challenger wins the America's Cup or x2: Defender wins the America's Cup (assuming no ties). Another example is the stock market, with possible outcomes x1: certain index closes below Z or x2: at or above Z. Alternately, the outcomes might be x1: index closes below Z, x2: in the range between Z and Z+100,x3: in the range Z+100 to Z+200, x4: in the range Z+200 to Z+300, or x5: above Z+300 (ignoring boundaries for now).

One example of a continuous event is the price of an index. Another example would be the time margin of victory of horse 1 (although that example is not frequently used). A third example is the difference between the NFC champion's score and the AFC champion's score in the Super Bowl.

For continuous events, it can be important to handle boundary conditions correctly so that aberrations do not appear. In FIG. 1, discontinuous boundaries (such as for the digital put, digital call and. digital range) are handled by taking the average of the two values. In this way, if the digital put and digital range contracts were combined, the payoff at x=a would be the notional N. In contrast, if the payoff function =N at all boundaries, then combining these two contracts would yield a payoff of 2N at the boundary x=a, which would be an undesirable anomaly. The boundaries can be handled in many ways. For example, the entire notional N can be allocated to one or the other of the contracts, so long as the sum was still N.

Also note that the payoff function can be either digital or not digital. A digital payoff function is one that can take on only two possible values (excluding boundary conditions). For example, the discrete, digital put, digital call and digital range contracts all have digital payoff functions: either 0 or the notional N. The two spreads have proportional payoffs, at least in the range of a<x<b. The call spread has a diverging slope (i.e., payoff increases as x increases) and the put spread has a converging slope (i.e., payoff decreases as x increases).

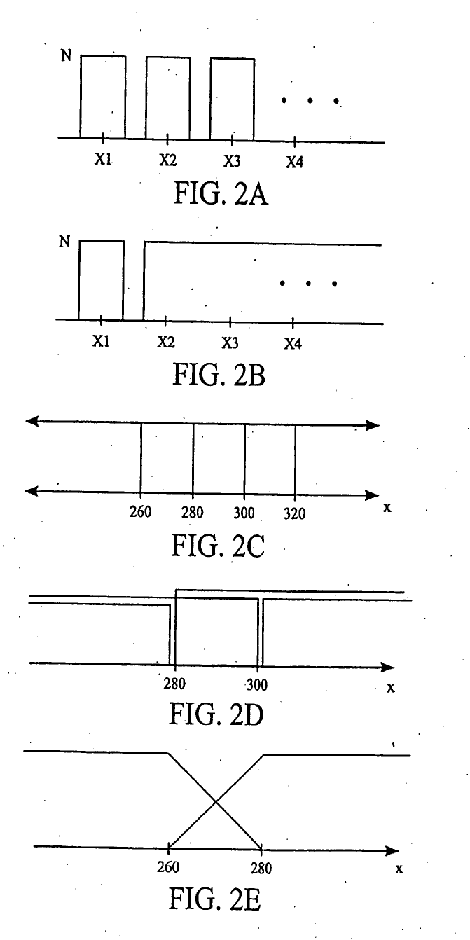

FIGS. 2A-2E illustrate the concept of complete sets. When someone holds a contract Cx, his payoff for that particular contact is P(Cx). When someone holds a set of contracts, the aggregate payoff for that set of contracts is the sum of the individual payoffs for each contract. A complete set of contracts is a set of contracts for which the aggregate payoff is a constant. This constant shall be referred to as the settlement value (SV) of the complete set. Mathematically, a set of contracts {Cn} is a complete set if
Σ P(Cn)=SV for all possible outcomes (Eqn. 1A)
where the summation is over all contracts n in the set. Graphically, the payoff diagram for a complete set is a constant line at payoff SV. Since the payoff diagram of a complete set is a constant value SV, the “fair market” price of a complete set (ignoring time value of money and transaction costs for now) is also SV. In other words,
Σ Price(Cn)=SV (Eqn. 1B)
where Price(Cn) is the price of contract Cn. The actual prices for the contracts may vary.

FIG. 2A shows a complete set for the discrete case. The possible outcomes are x1, x2, etc., which are assumed to be mutually exclusive and collectively exhaustive in this example. In other words, one and only one of the outcomes x1, x2, etc. must occur. The complete set is the set of contracts Cx1, Cx2, etc. covering all possible outcomes where each of these contracts has the same notional. In this way, regardless of which outcome occurs, the holder of the complete set will receive a payoff equal to the notional. It is like betting on both black and red in roulette (assuming no 0 or 00). As another example, if the event is a horse race, then the set of wagers that pays $10 if horse 1 wins, $10 if horse 2 wins, etc. is a complete set.

Complete sets can be formed in more than one way. FIG. 2B shows a different complete set for the discrete case. In this example, the complete set contains two contracts: Cx1 and C(not x1). C(not x1) pays the notional if any of x2, x3, etc. occur. Note that the contract C(not x1) is equivalent to the set of contracts {Cx2, Cx3, etc.} and the payoffs and fair market prices are related:
P(C(not x1))=P(Cx2)+P(Cx3)+ (Eqn. 2A)
Price(C(not x1))=Price(Cx2)+Price(Cx3)+ (Eqn. 2B)

Combining Eqns. 1B and 2B yields
Price(Cx1)=SV−Price(C(not x1)) (Eqn. 3A)
In other words, an offer to sell Cx1 at price Z or higher is equivalent in aggressiveness to an offer to buy C(not x1) at price (SV−Z) or lower. These concepts can be used to convert between short and long positions, as will be discussed in more detail below.

FIG. 2C is an example of a complete set for a continuous case. In this example, the complete set includes a digital put with upper bound x=260, three digital ranges that cover the range 260<x<320 in 20 point increments, and a digital call with lower bound x=320. All contracts have the same notional. Regardless of the value of x, the holder of the complete set will be entitled to receive a payoff equal to the notional. Note that the boundary conditions should be handled properly so that the payoff diagram of the complete set does not vary from the notional at the boundaries.

FIG. 2D is an example of a complete set formed by overlapping contracts. The boundaries are slightly shifted so the different contracts can be more clearly seen. In this case, the complete set includes three contracts: a digital put with upper bound 300 and notional N, a digital call with lower bound 280 and notional N, and a contract that is not(digital range of 280/300). This last contract has two pieces. The sum of the three contracts is a complete set with SV=2 N. In this example, the contracts are not mutually exclusive. For example, an outcome of x=282 will result in a payoff for both the digital call and the digital put.

FIG. 2E is an example of a complete set using non-digital payoff functions. In this example, a call spread and a put spread form a complete set. Both spreads are proportional in the range 260<x<280 and have the same nationals. Thus, the sum of the payoff diagrams is a constant with settlement value equal to the notional.

FIGS. 2A-2E are merely examples. Complete sets can be formed in many different ways. However, it is important to recall that a complete set of contracts will pay the settlement value regardless of the outcome of the underlying event. Thus, the fair market price for the complete set is its settlement value. As an example, assume three possible outcomes x1, x2 and x3. Further assume that each of the corresponding contracts Cx1, Cx2, Cx3 has a notional of N=$100. Then the set of three contracts Cx1, Cx2, Cx3 forms a complete set with SV=$100. Accordingly, if there is an opportunity to buy Cx1 for $50, Cx2 for $30 and Cx3 for $19 (or a total of $99), this is an opportunity to buy the complete set, which is worth $100, for only $99. It is a $1 arbitrage opportunity. Conversely, if there is an opportunity to sell Cx1 for $51, Cx2 for $31 and Cx3 for $19 (or a total of $101), this is an opportunity to sell a $100 complete set for $101. These are simple examples to illustrate the point. More complex examples, including taking advantage of the long/short equivalence described above, will be described in more detail below.

Put in another way, if a market organizer (or anyone else) buys just Cx1, it will be taking some contract risk depending on whether x1 occurs or not. However, if the organizer buys or sells a complete set at price SV, the organizer will not be taking any contract risk because the two are equivalent. Thus, the organizer can buy and sell complete sets for other purposes, for example to increase the liquidity of the market or reduce credit risk. For further examples of how this can be accomplished, see co-pending U.S. patent application Ser. No. 10/601,173, “Method and System for Utilizing a Special Purpose Vehicle for Improving the Liquidity of Transactions,” filed on Jun. 20, 2003; and co-pending U.S. patent application Ser. No. 10/600,903, “Method and System for Managing Credit-related and Exchange Rate-related Risk,” filed on Jun. 20, 2003; all of which are incorporated by reference herein.

The discussion thus far has also neglected certain other effects. For example, the time value of money has not been factored into the discussion. A payoff of $100 that occurs a year from now (e.g., when the underlying event is resolved) is not really worth $100 today. The discussion also does not account for transaction costs. However, these and other factors can be handled using conventional techniques.

Standard present value concepts can be used to account for the time value of money, allowing direct comparison of dollar figures. For example, Eqn. 1B states that the fair market price of a complete set should be the settlement value. However, if the payoff will occur one year from now, then, more precisely, the fair market price today of a complete set should be the settlement value, as measured in dollars one year from now, discounted by the annual interest rate. Or if the equation is cast in future dollars, then the fair market price today of a complete set, after interest for a year, should be equal to the settlement value, measured in future dollars.

Similarly, amounts can be adjusted up or down, as necessary, in order to account for transaction costs, profit or other effects. For example, if a minimum profit Z is desired, then the sum of the prices of the contracts in the complete set should be (SV−Z) or lower to yield profit Z for the buyer, or (SV+Z) or higher to yield profit Z for the seller. In the interest of clarity, all examples will continue to neglect these factors, with the understanding that they can be handled using conventional techniques. For further examples and discussion, see co-pending U.S. patent application Ser. No. 10/600,137, “Method and System for Improving the Liquidity of Transactions,” filed on Jun. 20, 2003; co-pending U.S. patent application Ser. No. 10/601,173,. “Method and System for Utilizing a Special Purpose Vehicle for Improving the Liquidity of Transactions,” filed on Jun. 20, 2003; and co-pending U.S. patent application Ser. No. 10/600,903, “Method and System for Managing Credit-related and Exchange Rate-related Risk,” filed on Jun. 20, 2003; all of which are incorporated by reference herein. Note that in these referenced patent applications, the term “initial settlement value” is used to refer to the settlement value when the events occur (i.e., when the contracts mature) and “settlement value” is used to refer to other time frames, so that time discounting may be used to equate the current settlement value with the initial settlement value.

As shown in FIGS. 2A-2E, complete sets can be formed in many different ways. In order to facilitate the formation of complete sets, it can be useful to define a special set of contracts, which shall be referred to as basic units. In many markets, the contracts traded in that market can take many different forms. They can also be quite complex. It can be difficult to try to assemble these “native” contracts into complete sets. As an alternative, the native contracts can be decomposed into an equivalent combination of basic units and complete sets are then formed using the basic units.

There can be many choices for the set of basic units. However, in many cases it is advantageous for the basic units to be digital with the same notional, and mutually exclusive and collectively exhaustive. In this case, it will be simpler to decompose the native contracts into basic units, and it will also be simpler to form the basic units into complete sets. Specifically, for any given contract, there will only be one possible decomposition into basic units. In addition, there will only be one way to form a complete set, and that is by including one of each basic unit. The settlement value of the complete set will equal the notional. For each basic unit, the event where the basic unit pays the notional shall be referred to as the state of the basic unit. The set of basic units preferably should also have the correct shapes so that all possible native contracts can be decomposed into basic units. While these characteristics are preferred, they are not required.

In the discrete case of events x1, x2, etc., one good choice of basic units is Cx1, Cx2, etc. where all contracts have the same notional. The states sn for the basic units Cx1, Cx2, etc. are then s1=x1, s2=x2, etc. This set of basic units is both mutually exclusive and collectively exhaustive. Furthermore, in many discrete cases, the “native” contracts are simply single event contracts (e.g., Cx5) so that each native contract is a basic unit. In cases where more complex native contracts are used, the decomposition into basic units is straightforward.

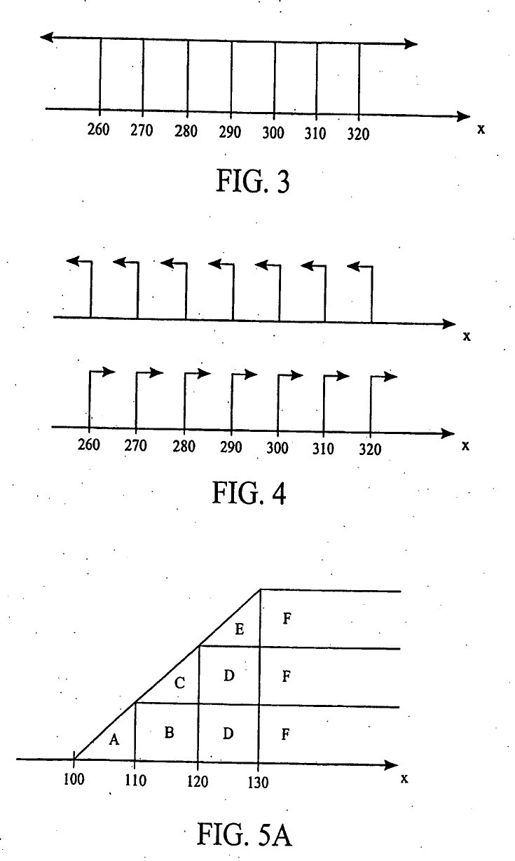

FIG. 3 shows a set of basic units for a case where the underlying event x is continuous but the payoff diagrams are all digital. The set of basic units is the digital put with boundary 260, the set of 6 digital ranges shown, and the digital call with boundary 320. All basic units have the same notional. This set of basic units can be used to decompose any native contract that has a digital payoff with boundaries at 260, 270, . . . 320.

The set of basic units can change over time. For example, if x approaches the upper end of the range, the set can be expanded to include more digital ranges at the high end. In addition, digital ranges at the low end can be decommissioned, with a corresponding change in the digital put. Alternately, if finer ranges are desired, the current digital ranges can be subdivided, for example using digital ranges with a span of 2 units instead of 10. The spans also are not required to be identical. When making these changes, it is preferable to select a new set of basic units that is backwards compatible with the old set.

FIG. 4 shows a set of basic units that are based on digital calls and digital puts, all with the same notional. Note that this set is not mutually exclusive. However, it can also be used to decompose any native contract that has a digital payoff with boundaries at 260, 270, . . . 320.

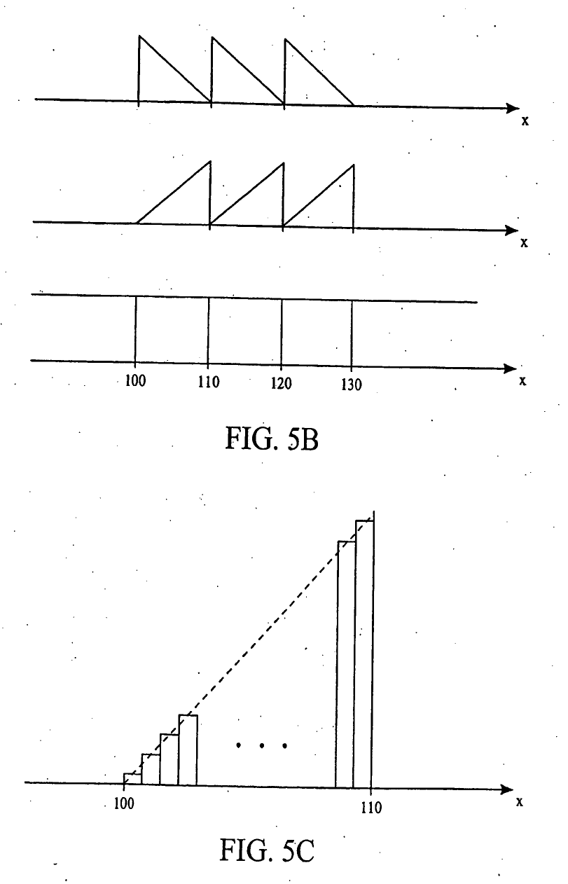

FIG. 5A illustrates the decomposition of a call spread into the following basic units: a diverging slope of 100/110 (the triangular region marked A), a digital range of 110/120 (rectangle B), a diverging slope of 110/120 (C), two digital ranges of 120/130 (D), a diverging slope of 120/130 (E), and three digital calls at 130 (F). All basic units have the same notional, although they are not all digital. More generally, if corresponding converging and diverging slopes are added to the set of basic units shown in FIGS. 3 or 4, then call spreads and put spreads can also be decomposed into basic units.

FIG. 5B shows a set of basic units that can be used to decompose the call spread in FIG. 5A. This set includes a digital put 100, a digital call 130, three digital ranges spanning 100/130, three converging basic units spanning 100/130, and three diverging basic units spanning 100/130. This set of basic units can be used to decompose any of the continuous contracts shown in FIG. 1, so long as the boundaries match those of the basic units (i.e., a and b are 100, 110, 120 or 130). Note that in addition to the complete set Eqns. 1-3 above, the relationships of the basic units also imply additional constraints. For example, the digital range 100/110 is equivalent to the sum of a converging 100/110 and a diverging 100/110. Therefore,

Price(converging 100/110)+Price(diverging 100/110)=Price (range 100/110)(Eqn. 3B) Thus, within this group of three basic units, there are really only two independent basic units with respect to fair market price. If the fair market prices of two of the basic units are known, then the fair market price of the third can be calculated by Eqn. 3B. An analogous situation exists for other relationships.

FIG. 5C shows an alternate set of basic units. Rather than using the triangular shaped converging and diverging basic units, a series of rectangular “sub” basic units is used to approximate the proportional payoff diagram. FIG. 5C shows the approximation of a diverging 100/110. The converging 100/110 would be approximated by the complimentary set of rectangular units, so that the two sets would sum to the notional. In many cases, the underlying variable x is not truly continuous. For example, it may have a tick value that is the smallest increment of x. In this case, the rectangular “approximation” becomes exact if the width of the rectangles equals the tick value. In one implementation, the “sub” basic units are chosen to have the same notional, so the rectangular unit closest to 100 may include one sub basic unit while the taller rectangular unit closest to 110 may include many sub basic units to reach the desired height.

The above are merely examples. For further examples of how to select a set of basic units, see co-pending U.S. patent application Ser. No. 10/600,137, “Method and System for Improving the Liquidity of Transactions,” filed on Jun. 20, 2003 and incorporated by reference.

The concepts of basic units can be important because they allow markets with many different types of contracts to be decomposed into basic units, which can then be used to facilitate the formation of complete sets. All of the following examples will be illustrated using discrete contracts with only a few possible outcome states, typically three to five, where the states are assumed to be mutually exclusive and collectively exhaustive. This is done for clarity. Otherwise, the examples will involve so many numbers as to obscure the point being illustrated. However, by using the concept of basic units, these simple examples can be extended to complex markets with many different types of contracts.

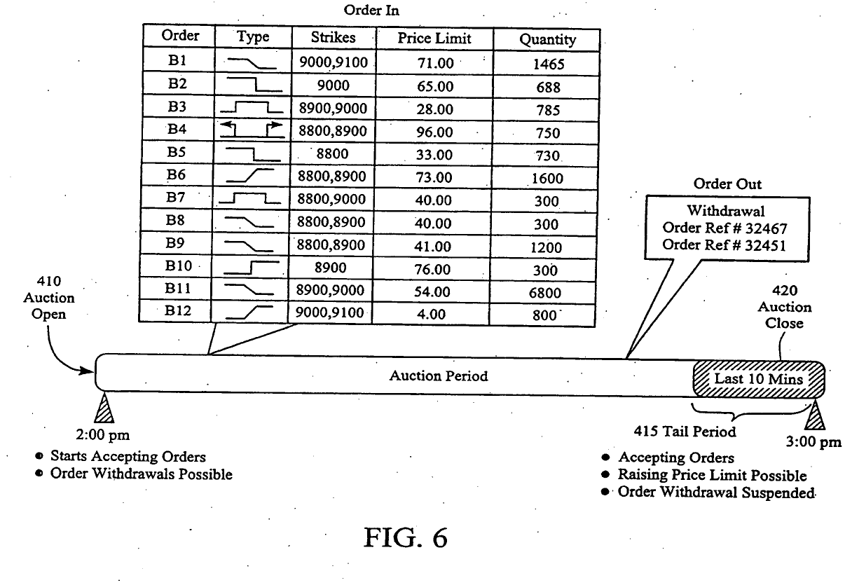

Let us now turn to auctions. FIG. 6 is an example timeline of an auction. At time 410 (2:00 pm in this example), the auction opens and begins accepting orders for contracts. Typically, the auction organizer will define the types of contracts that are supported by the auction. The auction continues for some period of time and then closes 420 (at 3:00 pm in this example), after which orders are no longer accepted. In the specific example of FIG. 6, there is also a tail period 415 where orders can no longer be withdrawn. At some point, the auction is settled, meaning that the price of contracts is determined and each pending order (i.e., the auction pool) is either filled or not. The events underlying the contract typically occur after the auction both closes 420 and settles.

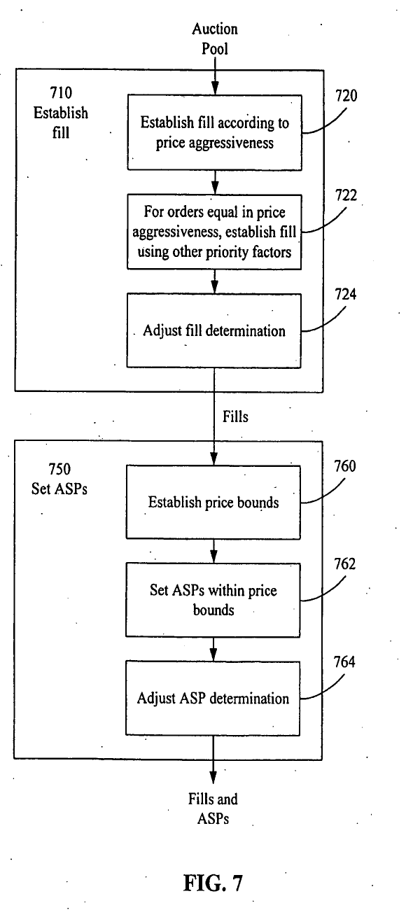

Settlement of the auction can occur in a number of ways. FIG. 7 is a flow diagram showing various ways of settling an auction according to the invention. In many conventional approaches, the final prices (i.e., the auction settlement prices or ASPs) for different contracts are set first, and then orders in the auction pool are either filled or not by comparing the price limits in the orders with the ASPs. In contrast, in FIG. 7, the fill for orders in the auction pool is established 710 without setting the ASPs. The fill defines a qualified pool of orders and an unqualified pool. The ASPs for orders in the qualified pool are then set 750 based on the previously established fill.

The interior of boxes 710 and 750 illustrate specific examples of these two steps. In this particular example of step 710, the fill is established 720 according to a price aggressiveness of the orders. Orders which are more price aggressive are given priority over less aggressive orders. In this context, price aggressiveness depends on price constraints or price limits in the orders but does not depend on the ASP since the ASP has not been set yet. In one approach, orders are filled so that an aggregate price aggressiveness for orders in the qualified pool is maximized. If some orders are equal in price aggressiveness, then other priority factors, such as time chop, can be used to determine 722 the fill among these orders. Some additional adjustment 724 may also be desirable, for example to ensure that all fills are an integer number if that is a requirement of the auction or to meet other constraints in the orders. Throughout steps 720-724, the process of establishing which orders are filled also attempts to form complete sets from the filled orders. Once the fill is established 710, one approach to step 750 first establishes 760 price bounds for the various contracts based on the price constraints in the orders in the qualified pool. The ASPs are then set 762 within these bounds, for example by interpolation between upper and lower price bounds. Additional adjustment 764 may also take place.

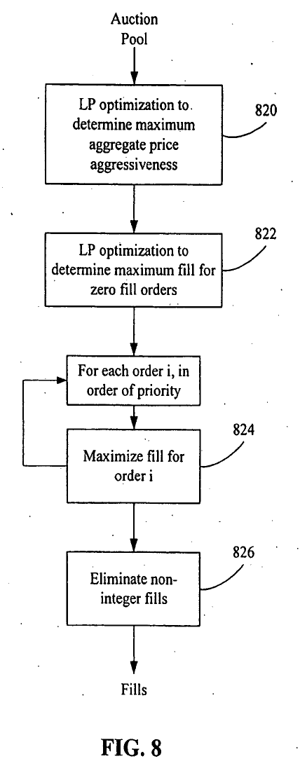

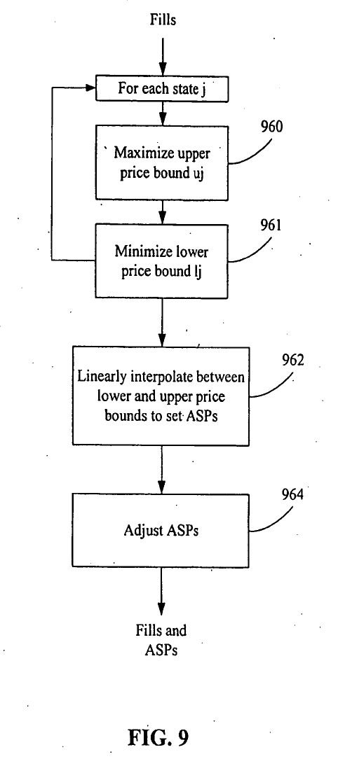

FIGS. 8-9 give further variations and examples of steps 710 and 750, respectively. The mathematical explanations are based on the following assumptions, in order to simplify the examples. These assumptions are not requirements. All contracts and orders are expressed in terms of basic units. The basic units are digital with the same notional, and they are also mutually exclusive and collectively exhaustive. For each basic unit, the event where the basic unit pays the notional is referred to as the state of the basic unit. All orders are assumed to be buy orders and may have a price limit and/or a quantity limit. The following nomenclature is used:
N notional, which is assumed to be 100
S total number of states (or basic units)
j=1, . . . , S state index
n total number of orders, all assumed to be buy orders
i=1, . . . , n order index
[πi,qi,ci] description of order i, where
   πi price limit for the order (contracts to be purchased for not more than πi per unit of contract)
   qi quantity limit for the order (not more than qi units of contract to be purchased)
   ci vector of length S, describing the contract ordered, in terms of the basic units
   cij the number of basic unit j contained in one unit of contract i
xi fill quantity for order i (xi units of order i will be filled)
zj fill quantity for the zero fill order for basic unit j (as explained below)
p vector of length S, with the ASP for each basic unit (the ASP for contract ci can be determined by taking the inner product of vectors p and ci)
pj ASP for basic unit j
M number of complete sets formed
   For example, the order [60,100,(1 1 0)] is an order to buy up to 100 units of a contract, where one unit of the contract consists of a combination of one unit of state 1 and one unit of state 2. One unit of state 1 is the contract that pays a notional $100 if state 1 occurs, and one unit of state 2 is the contract that pays a notional $100 if state 2 occurs. This order also sets a price limit of $60 for one unit of the contract. Note that (1 1 1) is a complete set with a settlement value of $100. Zero fill orders are single state buy orders with price limit 0 and unlimited quantity. For example, the zero fill order for state 3 is [0,∞,(0 0 1)]. Their utility will be explained below.

FIG. 8 and the following text describe various methods for establishing 710 the fill using LP optimization techniques, price aggressiveness and the notion of complete sets. One advantage of the specific mathematical formulations shown below is they are all LP optimizations, which is numerically efficient to solve. The method begins by performing 820 an LP optimization that maximizes an aggregate price aggressiveness, subject to constraints defined in the orders and also subject to forming complete sets. Mathematically, one formulation of the optimization is

$$Max {\sum }_{i = 1}^{n} {π}_{i} {x}_{i} - 100 M ⋯ AGG \\ s . t . \{ \begin{matrix}{x}_{i} \leq {q}_{i} & i = 1 … n \\ {\sum }_{i = 1}^{n} {c}_{ij} {x}_{i} + {z}_{j} = M & j = 1 … S\end{matrix} \qquad ( Optimization 1 )$$

The objective function is the aggregate price aggressiveness (AGG), which inherently contains information about the ASP p. The variables in this optimization are M (the number of complete sets) and xi and zj (the fill quantities of the orders and of the zero fill orders). The first constraint is that the fill quantity xi for order i cannot exceed the quantity limit qi in order i. The second constraint is that the total quantity filled for basic unit j must equal M for all basic units. In other words, the filled quantities form a total of M complete sets.

The AGG can be interpreted as the “profit over market” which would be realized if the filled quantities were all sold at their price limit (as opposed to the ASP). “Market” price for a complete set is the notional, which is 100 in this example. Put in another way, during the optimization, there will be a current qualified pool and current unqualified pool. If any orders in the unqualified pool can be combined to form a complete set with a price limit over 100, then AGG can be increased by moving these orders to the qualified pool. Similarly, if any orders in the qualified pool can be combined to form a complete set with a price limit under 100, then AGG can be increased by moving these orders to the unqualified pool. Thus, this optimization tends to select orders that can be combined into complete sets at prices over the notional.

In step 822, the fill for zero fill orders is maximized, subject to the same constraints in Optimization 1 and also subject to maintaining the AGG determined in Optimization 1. Mathematically, one formulation is

$$Max {\sum }_{j = 1}^{S} {z}_{j } ⋯ Z \\ s . t . \{ \begin{matrix}{x}_{i} \leq {q}_{i} & i = 1 … n \\ {\sum }_{i = 1}^{n} {c}_{ij} {x}_{i} + {z}_{j} = M & j = 1 … S \\ {\sum }_{i = 1}^{n} {π}_{i} {x}_{i} - 100 M = AGG & \end{matrix} \qquad ( Optimization 2 )$$

This optimization further enforces priority by price aggressiveness.

For example, consider an auction that contains the following orders: [30, 1, (1 0 0)], [75, 1, (0 1 0)], [75, 1, (0 1 1)]. The combination of one unit each of [30, 1, (1 0 0)] and [75, 1, (0 1 1)] will form a complete set that contributes 105-100=5 to the AGG. The combination of one unit each of [30, 1, (1 0 0)], [75, 1, (0 1 0)] and the zero fill order [0,∞,(0 0 1)] will also form a complete set that contributes 105-100=5 to the AGG. The second combination should be favored because [75, 1, (0 1 0)] is more price aggressive than [75, 1, (0 1 1)]. However, Optimization 1 does not distinguish between these two combinations. Optimization 2 does, and will select the more price aggressive combination since it increases the fill for the zero fill orders.

After fixing the aggregate price aggressiveness (AGG) and the fill for the zero-fill orders (Z), the orders are considered sequentially according to priority (other than price aggressiveness) and each order's fill will be maximized 824 in turn, subject to the fills of the previously considered orders. This can be used to break “ties” between orders that are equal in price aggressiveness.

For example if order 1 is [30, 100, (1 0 0)] and order 5 is [30, 200, (1 0 0)], the two orders are equal in price aggressiveness and Optimizations 1 and 2 will not distinguish between the two. If 150 units are to be allocated to these two orders, some other priority can be used to do the allocation. Time chop (i.e., time of receipt of the order) is one example. As other examples, certain size orders (e.g., either larger orders or smaller orders) may be preferred over others, or orders from certain customers may be given priority over others. Other priority factors can be used. If time chop is used and order 1 is received before order 5, then the fills will be x1=100 and x5=50.

One formulation is to consider each of the orders i in order of priority and to establish the fill xk for the current order being considered by

$$Max {x}_{k } s . t . \{ \begin{matrix}{x}_{i} = {X}_{i} & \begin{matrix}i = indices of orders \\ with higher priority\end{matrix} \\ {x}_{i} \leq {q}_{i} & \begin{matrix}i = indices of orders \\ with lower priority\end{matrix} \\ {\sum }_{i = 1}^{n} {c}_{ij} {x}_{i} + {z}_{j} = M & j = 1 … S \\ {\sum }_{i = 1}^{n} {π}_{i} {x}_{i} - 100 M = AGG & \\ {\sum }_{j = 1}^{S} {z}_{j} = Z & \end{matrix} \qquad ( Optimization 3 )$$

The optimization is run once for each order. Xi is the fill determined in previous Optimization 3's for orders with higher priority. The last three constraints are from the previous optimizations.

The previous optimizations may result in non-integer fills, which can be undesirable in some cases. Step 826 eliminates non-integer fills. One method to avoid non-integer fills is to use integer programming, but this typically will slow down the settlement process. Alternately, non-integer results can simply be rounded off to integer values, but the rounding may cause the formation of incomplete sets, which typically increases the risk for the auction holder.

Another approach is based on LP optimization. The fill for any order contains an integer part and a decimal part. For example, if fill x1=327.5, then the integer part is 327 and the decimal part is 0.5. In addition, the fills resulting from the above optimizations form many complete sets. The problem of non-integer fills can be addressed by removing complete sets until all orders have integer fills. For example, consider the three orders: [90,100,(2 1 0)], [40,100,(0 1 0)] and [50,101,(0 0 1)]. The fills are 50.5, 50.5 and 101, respectively, forming a total of 101 complete sets. Note that 0.5 unit of order 1, 0.5 unit of order 2 and 1 unit of order 3 also form a complete set. If this complete set is removed from the original fills, then the resulting fills are 50, 50 and 100, which are all integers. The non-integer fill results from insufficient demand in some orders and the ratio of orders forming a complete set not being equal to all ones. For the above example, the orders form complete sets in the ratio of 1:1:2.

The following is one formulation.

$$Min {M}^{′} s . t . \{ \begin{matrix}Decimal {x}_{i} \leq {x}_{i}^{′} \leq {q}_{i} & i = 1 … n \\ Decimal {z}_{j} \leq {z}_{j}^{′} \leq {z}_{j} & j = 1 … S \\ {\sum }_{i = 1}^{n} {c}_{ij} {x}_{i}^{′} + {z}_{j}^{′} = {M}^{′} & j = 1 … S\end{matrix} \qquad ( Optimization 4 )$$

where xi and zj are the fills from the previous optimizations, and Decimal xi and Decimal zj are the decimal parts of those fills. The variables in the optimization are M′ (the number of complete sets to remove), and x′i and z′j (the corresponding units of orders and zero fill orders, respectively). After reduction, the fills are new xi=old xi-x′i and new zj=old zj-z′j. In some cases, the optimization may be iterated or otherwise adjusted in order to eliminate the non-integer fills.

FIG. 8 is merely an example. Other variations will be apparent. For example, different objective functions can be used for the optimizations, techniques besides LP optimization can be used, or different formulations or approaches can be used to address the same problems. Even if the exact formulations shown above are used, not all of the steps need be used and they may be used in combination with additional other steps. For example, if all fills are integer or if non-integer fills are acceptable, then step 826 need not be used. Alternatively, if non-integer fills is an issue, it can be addressed by forcing integer behavior at some other point in the process. As another example, steps 822 and 824 also may not be needed in certain cases, for example if the corresponding problems are not present.

As another example, steps besides those shown can also be used and/or the steps can be performed iteratively. For example, adjustments of the fill can occur at any point in the process and adjustments for factors other than non-integer fill can be implemented. One example is that some orders may have a lower quantity limit. In other words, the order may be valid only if at least some minimum number of units can be purchased. Mathematically, either lower quantity limit ≦xi≦qi or xi=0. This constraint can be implemented by using the approach of Optimization 4, but replacing the lower bound of “Decimal xi” with a quantity that depends on the lower quantity limit for the order. For example, if the fill of order 4 is determined to be 100 but order 4 has a lower quantity limit of 500, then Optimization 4 can be run with the constraint x′4=100. The optimization will attempt to remove complete sets with 100 x4, thus fulfilling the requirement of a minimum order of 500 by not filling order 4. Alternately, if the initial fill determination indicates that order 4 will not be filled because it is allocated 100 units but requires a minimum of 500 units, then the entire fill determination can be iterated but removing order 4 from the auction pool for subsequent iterations (or, equivalently, by force x4=0 in Optimization 1 and subsequent optimizations).

Returning to FIG. 7, once the fills are established 710, the ASPs are then set 750. The fills from step 710 can be expressed by xi and zj. The fill step 710 also determines a qualified pool and an unqualified pool. In one approach, the qualified pool is defined as orders that are filled (i.e., xi>0) and the unqualified pool is defined as orders that are not filled (i.e., xi=0). The qualified and unqualified pools can also be defined in other ways. FIG. 9 and the corresponding text describe various ways for setting 750 the ASP. One advantage of the specific mathematical formulations is they are all LP or QP optimizations. As with FIG. 8, these are merely examples.

The qualified and unqualified pools impose price bounds on the states and, in one approach, some or all of these price bounds are used to set the ASPs. For qualified orders, the ASPs of the states should not violate the price limits of the orders. Mathematically, the price bounds imposed by qualified orders i are

$${\sum }_{j = 1}^{S} {c}_{ij} {u}_{j} \geq {π}_{i} \\ {\sum }_{j = 1}^{S} ( 1 - {c}_{ij} ) {l}_{j} \geq 100 - {π}_{i} \qquad ( Eqn . 4 )$$

where lj and uj are the lower and upper price bounds for basic unit j. The second inequality is the buy-sell reflection of the original orders (assuming that the maximum value of all cij is 1). The ASP for basic units should satisfy both the buy side and sell side.

Unqualified orders also impose price bounds. The ASPs of the states should not make unqualified orders tradable. Mathematically, for unqualified orders i, the constraints corresponding to Eqn. 4 are

$${\sum }_{j = 1}^{S} {c}_{ij} {u}_{j} \geq {π}_{i} \\ {\sum }_{j = 1}^{S} ( 1 - {c}_{ij} ) {l}_{j} \leq 100 - {π}_{i} \qquad ( Eqn . 5 )$$

These constraints are especially useful when there are no qualified orders and an indicative price is desired.

FIG. 9 shows one example for setting ASP based on maximizing the upper price bound and minimizing the lower price bound of each state, where the maximizations and minimizations are performed separately for upper and lower price bounds and also separately for each state. In other words, if a first optimization determines that the upper price bound u1=85, that value is not fixed for subsequent optimizations that find l1, u2, l2, u3, l3, etc. In step 960, the upper price bound of basic unit j is maximized. One formulation is

$$Max {u}_{j} s . t . \{ \begin{matrix}{x}_{i} > 0 ⇒ {\sum }_{j = 1}^{S} {c}_{ij} {u}_{j} \leq {π}_{i} \\ {x}_{i} > 0 ⇒ {\sum }_{j = 1}^{S} ( 1 - {c}_{ij} ) {l}_{j} \geq 100 - {π}_{i} \\ {l}_{j} \leq {u}_{j} \\ {\sum }_{j = 1}^{S} {l}_{j} \leq 100 \\ {\sum }_{j = 1}^{S} {u}_{j} \leq 100\end{matrix} \qquad ( Optimization 5 )$$

The first two constraints are the price limits imposed by the qualified pool (Eqn. 4). The qualified pool is used in the following examples, but this is purely for illustrative purposes. Any combination of constraints from the qualified and unqualified pools can be used. The third constraint requires that the lower price bound must be less than or equal to the upper price bound. The last two constraints are added as a safety check, as they should be automatically satisfied. The sum of the ASPs should equal 100 (the notional). Requiring that the sum of the lj≦100 and the sum of the uj≧100 is a check that the ASPs will fall between the lj and the uj. This is preferred since the ASPs can then be determined by interpolation, rather than by extrapolation. Extrapolation is more unpredictable and more likely to yield unacceptable results.

In step 961, the lower bound is found in a similar fashion. The formulation corresponding to Optimization 5 is:

$$Min {l}_{j} s . t . \{ \begin{matrix}{x}_{i} > 0 ⇒ {\sum }_{j = 1}^{S} {c}_{ij} {u}_{j} \leq {π}_{i} \\ {x}_{i} > 0 ⇒ {\sum }_{j = 1}^{S} ( 1 - {c}_{ij} ) {l}_{j} \geq 100 - {π}_{i} \\ {l}_{j} \leq {u}_{j} \\ {\sum }_{j = 1}^{S} {l}_{j} \leq 100 \\ {\sum }_{j = 1}^{S} {u}_{j} \leq 100\end{matrix} \qquad ( Optimization 6 )$$

Once the upper and lower price bounds are determined, a price within that range is determined. One approach uses linear interpolation 962 between the upper and lower price bounds. One formulation is

$${p}_{j} = \frac{{l}_{j} ( {\sum }_{k = 1}^{S} {u}_{k} - 100 ) + {u}_{j} ( 100 - {\sum }_{k = 1}^{S} {l}_{k} )}{{\sum }_{k = 1}^{S} ( {u}_{k} - {l}_{k} )} \qquad ( Eqn . 6 )$$

These prices reflect the relative demand of different states and this formulation automatically ensures that the sum of prices pj equals 100 (the notional). However, the resulting prices pi may violate the price constraints imposed by the orders. This is generally undesirable. As a result, prices can be adjusted 964 so that they no longer violate these price constraints. In one approach, the prices determined by Eqn. 6 are used as an initial starting point, and new prices are determined by minimizing the variance from these initial prices while requiring that price constraints in the orders be met. One formulation is

$$Min {\sum }_{j = 1}^{S} {( {p}_{j} - {p}_{j}^{′} )}^{2} s . t \{ \begin{matrix}{x}_{i} > 0 ⇒ {\sum }_{j = 1}^{S} {c}_{ij} {u}_{j} \leq {π}_{i} \\ {x}_{i} > 0 ⇒ {\sum }_{j = 1}^{S} ( 1 - {c}_{ij} ) {l}_{j} \geq 100 - {π}_{i} \\ {\sum }_{j = 1}^{S} {p}_{j} = 100 \\ {\sum }_{j = 1}^{S} {z}_{j} {p}_{j} \leq R\end{matrix} \qquad ( Optimization 7 )$$

where p′j are the initial prices from Eqn. 6 and pj are the final ASPs. In this example, an additional fourth constraint is added. Recall that zj is the fill for zero fill orders. These orders do not correspond to any real orders in the auction pool. They represent a deviation of the qualified pool from complete sets. Hence, if they are priced at non-zero levels (which typically will be the case), then the auction holder or some other party will have some risk for these orders. In this optimization, the total risk for zero fill orders is limited to R.

An alternate approach determines the upper and lower price bounds by maximizing the sum of the price gaps for all states instead of individually maximizing each price gap for each state. A reference price h is introduced. The optimization will simultaneously try to minimize the variance of the price bounds from h. The reference price h can be a historical price, a price set by the auction organizer, the price from other price setting mechanisms or any other price. In this example, the maximization of the sum of the price gaps and the minimization of the variance relative to h is accomplished in one optimization, for example

$$Max K * {\sum }_{j = 1}^{S} ( {u}_{j} - {l}_{j} ) - {\sum }_{j = 1}^{S} {( {u}_{j} - {h}_{j} )}^{2} - {\sum }_{j = 1}^{S} {( {h}_{j} - {l}_{j} )}^{2} \\ s . t . \{ \begin{matrix}{x}_{i} > 0 ⇒ {\sum }_{j = 1}^{S} {c}_{ij} {u}_{j} \leq {π}_{i} \\ {x}_{i} > 0 ⇒ {\sum }_{j = 1}^{S} ( 1 - {c}_{ij} ) {l}_{j} \geq 100 - {π}_{i} \\ {l}_{j} \geq 0 \\ {l}_{j} \leq {u}_{j} \\ {u}_{j} \leq 100 \\ {\sum }_{j = 1}^{S} {l}_{j} \leq 100 \\ {\sum }_{j = 1}^{S} {u}_{j} \geq 100 \\ {\sum }_{j = 1}^{S} {z}_{j} {u}_{j} \leq R\end{matrix} \qquad ( Optimization 8 )$$

The constant K can be used to adjust the relative importance of the price gap term and the variance terms. K will be large if the primary goal is to maximize the price gaps. Once the upper and lower price bounds are determined, the actual prices pj can be set as described previously.

Now consider a numerical example. Suppose there are three states and six orders:

Order 1: [26,150,(1 0 0)]

Order 2: [25,200,(1 0 0)]

Order 3: [77,100,(0 1 0)]

Order 4: [77,1200,(0 1 0)]

Order 5: [80,500,(0 0 1)]

Order 6: [20,300,(1 0 1)]

In this example, the auction is settled using the specific formulations described above.

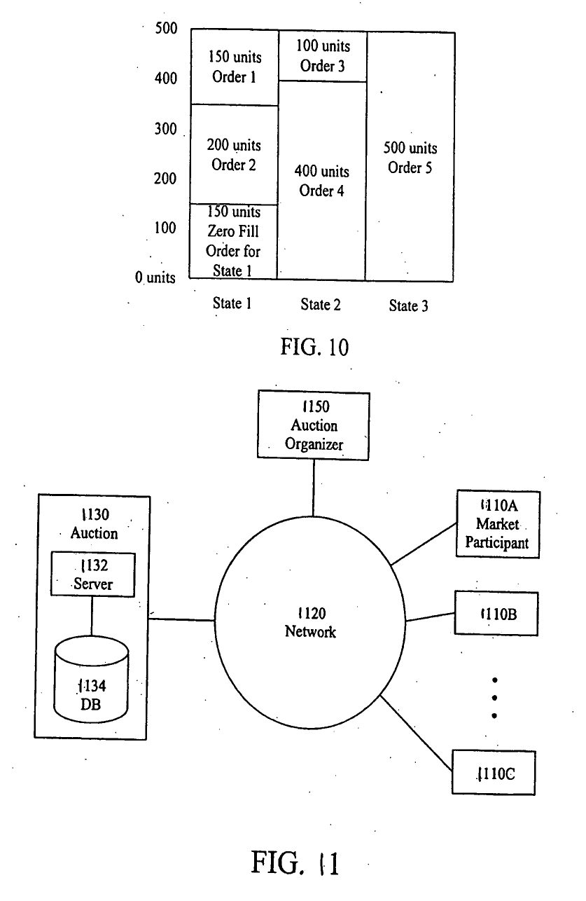

First, the fill is established. Optimization 1 results in a maximum AGG=$37400 with a fill of 150, 200, 0, 500, 500, 0 for Orders 1-6 and a fill of 150 for the zero fill order for state 1. Optimization 2 is performed but does not change the result in this example. Optimization 3 allocates fill between Orders 3 and 4. It is possible to vary the fill of Order 3 and Order 4, as long as their sum of fills equal to 500, since they have the same shape and price limit. To make the fills uniquely determined, the fill is optimized according to their priority (time chop for example). Assume that Order 3 has higher priority than Order 4, then their fills are 100 and 400 respectively. There are no non-integer fills at this point, so Optimization 4 is skipped. The final fill is 150, 200, 100, 400, 500, 0 for Orders 1-6 and 150 for zero fill order 1. This result is shown graphically in FIG. 10.

Given this fill, ASPs can be determined in a variety of ways. For example, applying Optimizations 5 and 6 yields the price bounds shown in rows 1 and 2 of Table 1. Row 3 shows the linearly interpolated price as determined by Eqn. 6. Optimization 7 is performed to ensure that the price limits of qualified orders are not violated. Row 4 shows the results where the 150 zero fill orders for state 1 are limited to a total of $100 (or price of $0.67). This corresponds to R=100 in Optimization 7. Row 5 shows the ASPs without the risk constraint.

TABLE 1

| | State 1 | State 2 | State 3 |
|---|---|---|---|
| Upper Price Bound | $25.00 | $77.00 | $80.00 |
| Lower Price Bound | 0 | 0 | 0 |
| Interpolated Price | 13.75 | 42.30 | 43.95 |
| ASP (with Risk | 0.67 | 48.84 | 50.49 |
| Constraint) | | | |
| ASP (without Risk | 13.75 | 42.30 | 43.95 |
| Constraint) | | | |

As an alternate method for determining the ASPs, Optimization 8 can be applied instead. Alternately, the results shown in Table 1 can be used as the h values for Optimization 8. For this example, let h be (13.75, 42.30, 43.95), which are the ASPs in Table 1 without risk constraint. Also include the same risk constraint of R=$100 as before. The upper and lower price bounds are shown in Table 2. These are linearly interpolated to determine the ASPs, as shown in row 3.

TABLE 2

| | State 1 | State 2 | State 3 |
|---|---|---|---|
| Upper Price Bound | $0.67 | $77.00 | $80.00 |
| Lower Price Bound | 0.01 | 36.66 | 38.34 |
| Interpolated Price | 13.75 | 42.30 | 43.95 |
| ASP (with Risk | 0.21 | 48.86 | 50.93 |
| Constraint) | | | |

The examples given above used certain types of contracts and orders for clarity but the invention is not limited to these. For example, all orders were buy orders in the above examples. Sell orders can be handled in an analogous fashion. If interest and transactional costs are ignored, selling some contracts at a price p is equivalent to buying the complementary contracts at a price of N-p. For example, a sell order of [30,100,(1 0 0)] is equivalent to a buy order of [70,1 00,(0 1 1)]. If state 1 is the winning state, both orders will lose $70 per contract and if state 1 is not the winning state, both orders will gain $30 per contract. In one approach, if the auction pool contains a mixture of buy and sell orders, orders of one type can be transformed to equivalent orders of the other type for purposes of settling the auction.

As another example, orders may have constraints other than price or quantity. For example, some orders may limit price and total investment amount. There is a relationship between price, quantity and investment amount:
Investment Amount=Quantity×Price (Eqn. 7)
Thus, an order that limits total investment amount and price can be modeled as an equivalent order with quantity and price limits. As an example, assume that an order has an investment limit of $1000 and a price limit of $25. This is equivalent to an order with a quantity limit of $1000/ASP and a price limit of $25. In all events, the bidder is willing to buy at least $1000/$25=40 units. So, as a conservative estimate, this order can be modeled as an equivalent order with a quantity limit of 40 and a price limit of $25. If the settlement process results in an ASP of $10, which is significantly below the price limit of $25, then the process could be iterated with a new quantity limit of $1000/$10=100 or something between 40 and 100. The price limit can also be reduced accordingly. Other variations will be apparent.

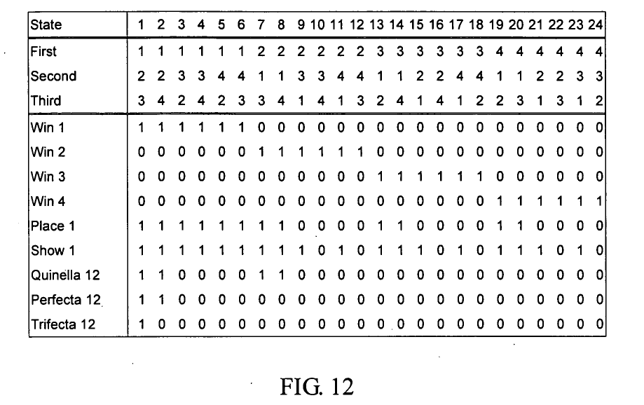

As another example, as mentioned previously, the examples used above were based on discrete contracts with only a few possible outcome states, typically three to five. This was done for clarity. However, by using the concept of basic units, these simple examples can be extended to complex markets with many different types of contracts. The concepts of basic units allows markets with many different types of contracts to be decomposed into basic units, which can then be used to facilitate the formation of complete sets or to otherwise settle the auction. FIGS. 12-16 give three examples: one based on a pool of bets for horse racing, one based on bets for football scores, and one based on orders for vanilla options.

One type of betting is based on the outcome of a race. Payoffs for bets may depend in part, or entirely, on the finish order for the race. In horse racing, the bets typically depend solely on the finish order of the top 3 finishers. The types of bets that can be placed are pre-defined (win, place, show, quinella, exacta, trifecta, etc.) and the bets are for a fixed amount. Example bets are $25 on horse 1 to win and $10 on a quinella on horses 2 and 5. The methods described above and other auction settlement methods can be applied to horse racing or other similar betting events as follows.

First, the bets are contracts that limit investment amount. Some auction settlement methods are based on contracts with price limits rather than investment amount limits. In these cases, the investment amount limits can be converted to equivalent price limits because there is a direct relationship between the odds, the investment amount and the price for a contract of constant notional. For example, assume that a $10 notional is used. A bet of $25 on horse 1 to win at 3:1 odds is the same as purchasing 10 units of a $10 notional contract for horse 1 to win at a price of $2.50 per unit. This can be seen as follows. The 3:1 odds means that a $25 bet will return $100 if horse 1 wins (the 3:1 payoff plus the original $25). A return of $100 is the payoff for 10 units of the $10 notional contract. To purchase 10 units for a total of $25, the per-contract price must be $2.50. Therefore, setting any two of the price for the notional contract, the odds and the investment amount will determine the third. This equivalence can be used to convert the original bets into equivalent price-limited contracts, if that is required for the specific auction settlement approach.

Second, the different types of bets preferably should be treated in a manner that facilitates the formation of complete sets. The native bets themselves usually are not mutually exclusive and are difficult to assemble into complete sets. So instead of working with the native bets themselves, a set of basic units is selected, the native bets are expressed as combination orders of the basic units and these combination orders are used to facilitate the formation of complete sets and the settlement of the auction (i.e., the pool of bets).

As an example, assume that a horse race is limited to the following types of bets:
Win: Bettor wins if his chosen horse finishes first.
Place: Bettor wins if his chosen horse finishes first or second.
Show: Bettor wins if his chosen horse finishes first, second or third.
Quinella: Bettor wins if his chosen two horses finish first and second, in either order.
Exacta: Bettor wins if his chosen two horses finish first and second in the order predicted.
Trifecta: Bettor wins if his chosen three horses finish first, second and third in the order predicted.
   In this case, the payoffs depend only on the first, second and third place horses. Therefore, the outcome has NP3 possible states, where N is the number of horses running. Each of these states can be used as the basis for a basic unit and the native bets can be decomposed into combinations of these basic units.

FIG. 12 shows an example with four horses. The rows labeled “First”, “Second” and “Third” show which horses finish first, second and third. In the first column (state 1), horse 1 wins, horse 2 finishes second and horse 3 third. In state 14, horse 3 wins, horse 1 is second and horse 4 is third. The 24 different states are labeled 1-24 for convenience. The bulk of the table shows the combination orders for different types of native bets. The row “Win 1” shows the vector [1 1 1 1 1 0 0 0 0 0 0 0 0 0 0 0 0 0 0 0 0 0 0]. This means that a $10 notional on horse 1 to win is equivalent to a combination of a discrete contract for state 1 with a $10 notional, plus a discrete contract for state 2 with a $10 notional, plus . . . a discrete contract for state 6 with a $10 notional. Similarly, a $10 bet on Show 1 (horse 1 to show) is equivalent to a combination order for the basic units for state 1-9, 11, 13-15, 17, 19-21 and 23. For convenience, the table does not show all possible bets that can be made but shows representative bets in order to illustrate the principle of expressing native bets as combinations of basic units.

This set of basic units has good characteristics. The basic units are mutually exclusive and collectively exhaustive. If each basic unit has the same notional, then a combination with one of each basic unit will form a complete set and that will be the only way to form a complete set. In addition, this set of basic units is efficient, meaning that no two (or more) of the basic units can be merged together to form a new set with fewer basic units that is still capable of supporting all of the possible types of native bets.

As an example of a set of basic units that is not efficient, consider a set that considers the top four finishers in a horse race. In this set, one basic unit will correspond to the 1-2-3-4 finish, another to the 1-2-3-5 finish, another to the 1-2-3-6 finish, etc. This set is mutually exclusive and collectively exhaustive but it is not efficient. For the bets shown above, there is no reason to distinguish between the 1-2-3-4, 1-2-3-5, etc. finishes and all of these basic units will always behave the same in the combination orders for any native bet. That is, the combination order for any given native bet will have the same number of units of 1-2-3-4, 1-2-3-5, etc. Thus, they could be merged into a single basic unit, one that corresponds to 1-2-3-x where x is any horse (state 1 in FIG. 12), and this new set of basic units could support all of the possible types of native bets with a fewer number of basic units.

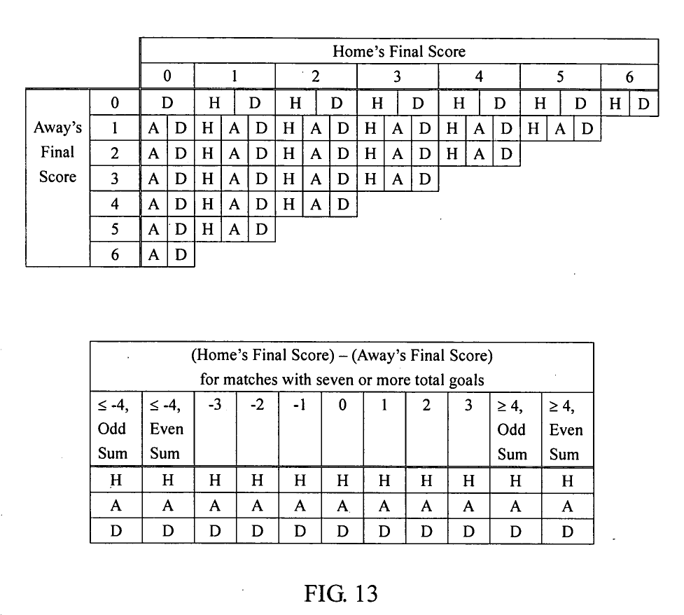

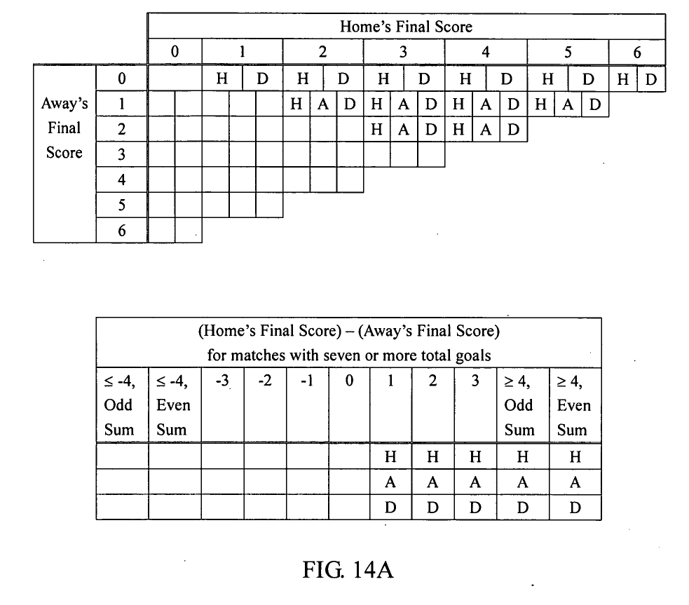

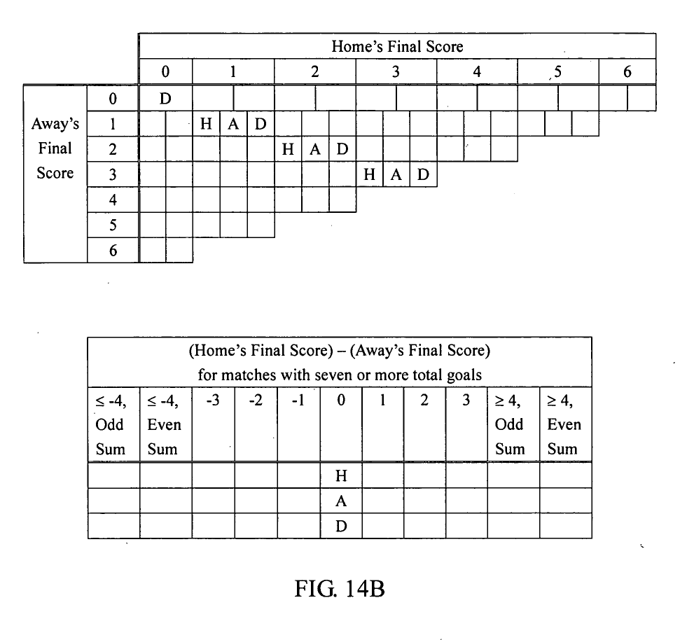

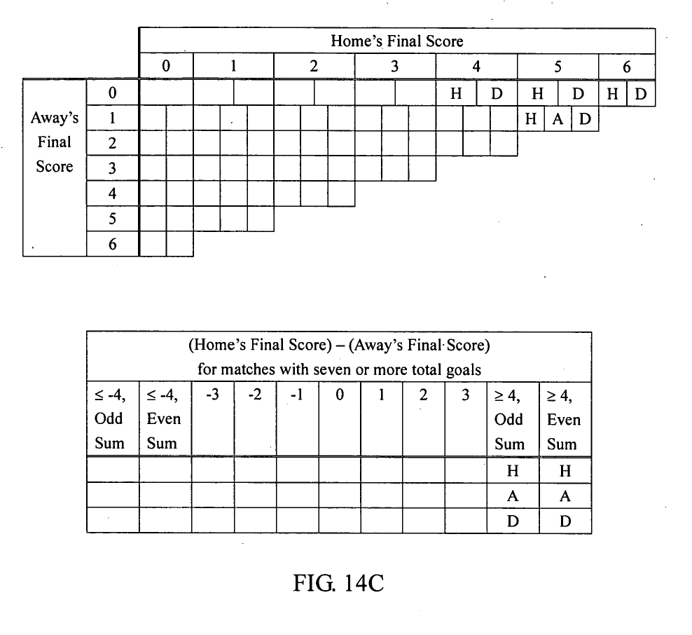

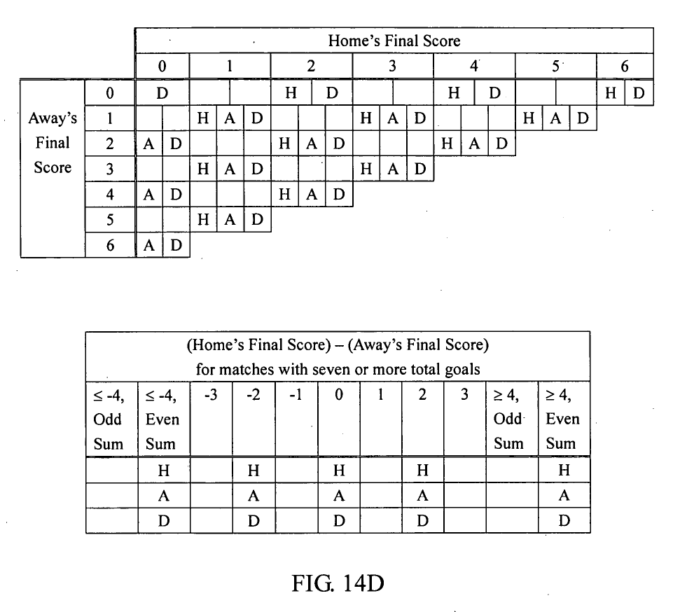

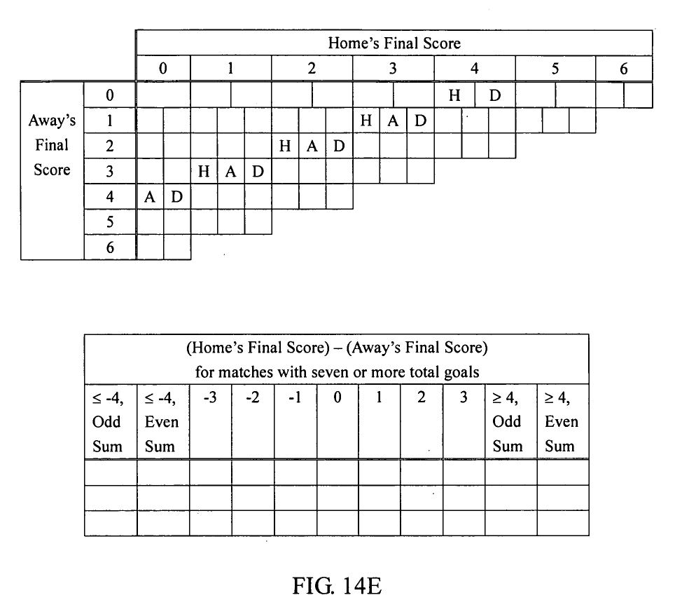

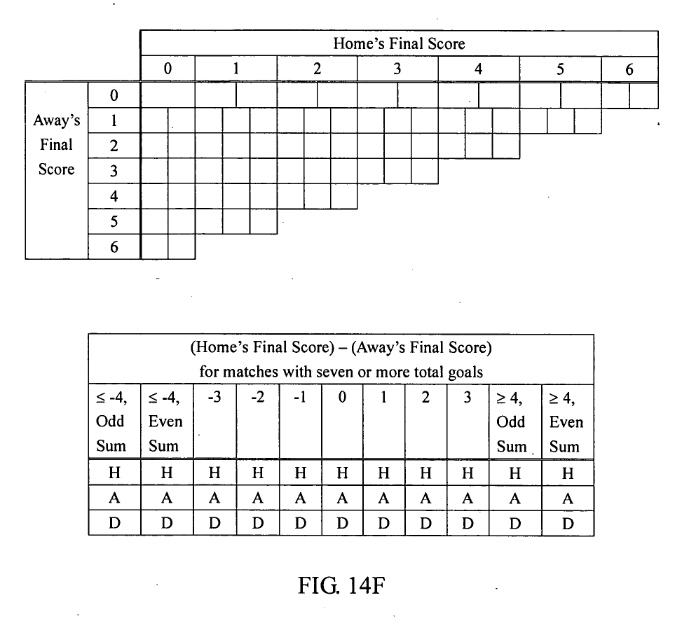

Another type of betting is based on a competition between two competitors (e.g., two teams or two individuals) that score points according to the rules of the competition. The payoff for bets depends on the scoring by the two competitors. FIGS. 13-14 show an example based on football (soccer). For this example, assume that the following types of bets can be placed on a football match:
Home/Away/Draw (HAD): Bettor wins if he correctly predicts whether the football match will end in a Home win, an Away win or a Draw.
Handicap HAD: Same as HAD, but the official score is adjusted by a handicap number of goal(s). The weaker team is given a handicap advantage and the stronger team therefore has a handicap disadvantage. The handicap is an integer number of goal(s) (e.g. 1, 2, 3 . . . etc.). The official score is adjusted by the goals handicap and H/A/D is determined based on the handicap-adjusted score. For this example, assume that the handicap cannot be more than 3 goals.
Half/Full (HaFu): Bettor wins if he correctly predicts H/A/D for both the half time score and the final score. No handicapping. There are nine possible outcomes for HaFu betting: HH, HD, HA, DH, DD, DA, AH, AD and AA (first letter indicates the halftime outcome and last letter indicates the final outcome.
Odd/Even: Bettor wins if he correctly predicts whether the total number of goals scored is odd or even. No goal scored in a match is deemed even.
Total Goals: Bettor wins if he correctly predicts the total number of goals scored in the match. For this bet, a total of seven or more goals scored is considered to be a single bet.

FIG. 13 shows two tables that diagram a set of basic units that can be used to support all of these types of bets. The top table provides a structure for matches where the total goals scored is less than seven. The bottom table provides a structure for matches where the total goals scored is seven or more. Because of the types of bets that can be placed, it is more efficient to have one structure for low scoring outcomes and a different structure for high scoring outcomes. In this case, the dividing line between high and low scoring is at seven total goals, but the dividing line may be different in other cases and need not be exactly at a certain number of total goals. For example, certain types of 6-8 total goals may be better treated within the low scoring structure while other types of 6-8 total goals may be better treated within the high scoring structure. Returning to the tables, each of the letters H, A and D in the body of a table represents a different basic unit. For each entry in either table, the basic unit is a discrete contracts that pays the notional when the half-time score matches the H/A/D entry in the table and the final score matches the row/column index in the table.

For example, in the low scoring table, the H in column 2 row 3 represents the discrete contract that pays when the half-time score is Home leading and the final score is Home 2 Away 3; the A in column 2 row 3 pays upon a half-time score of Away leading and a final score of Home 2 Away 3, and the D in column 2 row 3 pays upon a tied half-time score and a final score of Home 2 Away 3. Note that if one of the final scores is 0, then the possibilities for half-time scores is reduced. For example, Away can never be leading at half-time if its final score is 0.

In the high scoring table, the H/A/D entry represents the half-time result but each column corresponds to a different difference between Home's final score and Away's final score. For differences with a magnitude greater than 3, there is a further subdivision into whether the total number of goals is odd or even. Thus, a final score of Home 3, Away 5 would correspond to one of the three entries in column “−2” (the specific entry would depend on the half-time score), Home 3 Away 8 would correspond to column “≦−4, Odd Sum”, and Home 9 Away 3 would correspond to column “≧4, Even Sum.” Note that a final score of Home 3 Away 1 would not correspond to any of the entries under column “2” because the total goals scored is not more than 7. That final score would be handled in the low scoring table instead (under column 3, row 1).

The H/A/D entries in these two tables represent a set of basic units that can be used to support all of the different types of native bets described above. This set has approximately 100 basic units, which is significantly less than the total number of possible combinations of native bets. FIGS. 14A-14F show the combinations that correspond to different types of native bets. In these figures, an H/A/D that is showing means that particular basic unit is included in the combination. An absent letter means the basic unit is not included. FIGS. 14A and 14B shows the combinations for an HAD bet of H wins and of a Draw, respectively. The combinations for HaFu bets can be derived from these by including only the correct half-time result. For example, a HaFu bet of HH corresponds to only the H entries of FIG. 14A (i.e., delete all of the A and D entries). FIG. 14C shows the combination for a Handicap HAD bet of H with a H handicap of 3 goals (i.e., H must win by more than 3 goals). FIG. 14D shows the combination for an Odd/Even bet of even. Note that in the high scoring table, if the difference between Home's final score and Away's final score is even (or odd), then the sum of the scores will also be even (or odd). FIGS. 14E and 14F show the combinations for Total Goal bets of 4 and 7+, respectively.

Now consider the case of vanilla options. Assume for this example that traders may buy or sell any type of digital call/put, digital range, call/put spread or vanilla call/put option so long as the strike price(s) is either 14700, 14800, 14900 or 15000. In most practical applications, the number of possible strike prices will be much larger. It has been limited here purely so the example will not become unwieldy.

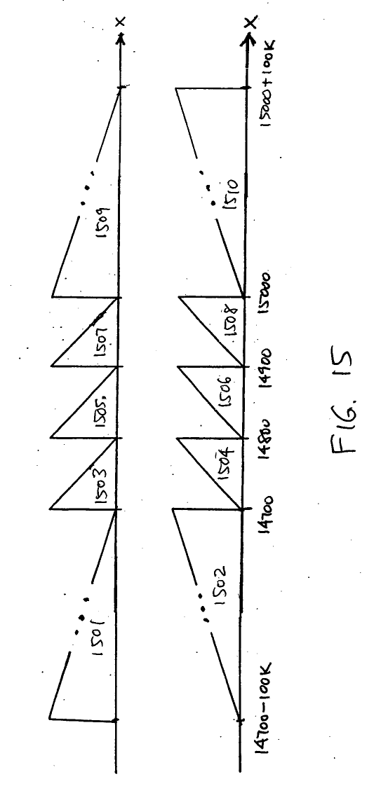

FIG. 15 shows a set of basic units 1501-1510 that can be used to support these types of orders. This set includes five converging basic units (the odd-labeled units) and five diverging basic units (the even-labeled units). All of the basic units have a notional of $100 (i.e., maximum payoff is $100). The three converging and three diverging basic units 1503-1508 between the lowest strike price of 14700 and the highest strike price of 15000 are similar to the basic units shown in FIG. 5B. In this case, each basic unit spans a price range of $100 and has a maximum payoff of $100, with a slope of either +1 or −1. Each converging basic unit can be combined with the corresponding diverging basic unit to form a digital range. Other notionals and slopes can be used, but a slope of +1/−1 is convenient for supporting most types of spread and option orders.

The other basic units 1501, 1502, 1509, 1510 are slightly different. They have the same notional but their range is much larger. For example, basic unit 1510 begins at the highest strike price 15000 and ends at 15000+100K, 100K is some large number. Ideally, 100K would be infinity but in practical implementations, 100K is selected to be a large number that, for practical purposes, behaves the same as infinity. Note that K units of basic unit 1510 will have a slope of +1.

Now let [ci] be the vector of length 10 that describes a particular combination order: c1 is the number of units of basic unit 1501, c2 is the number of basic unit 1502, etc. A complete set is formed by the vector [1 1 1 1 1 1 1 1 1 1]. Note that this vector does not account for possible payoffs if the underlying variable reaches values above 15000+100K or below 14700-100K. However, if K is selected to be large enough, then the probability of either of those events will approach or equal zero and the vector will represent a complete set.

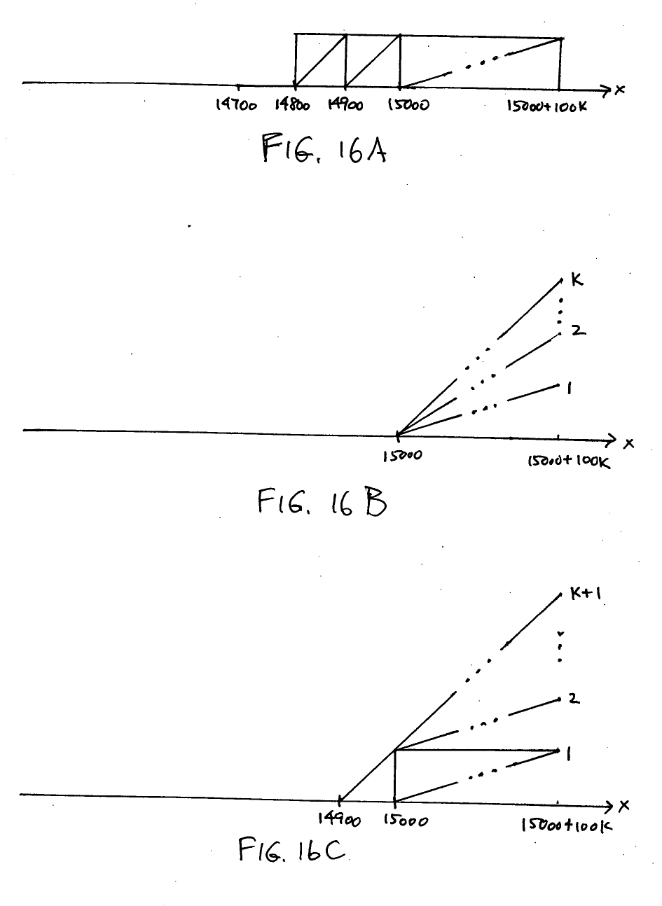

FIGS. 16A-16C show the decomposition of some representative orders using this set of basic units. FIG. 16A shows the decomposition of a digital call with strike price 14800. The combination order for this digital call is [0 0 0 0 1 1 1 1 1 1]. FIG. 16B shows the decomposition of a vanilla call order with strike price 15000. It is decomposed into K units of the basic unit 1510. The corresponding vector is [0 0 0 0 0 0 0 0 0 K]. FIG. 16C shows the decomposition of a vanilla call order with strike price 14900. The combination vector is [0 0 0 0 0 0 0 1 1 K+1].

As mentioned above, K should be selected large enough so that the residual portion above 15000+100K is negligible. In addition, with a large K, vanilla orders (such as shown in FIGS. 16B and 16C) will not combine with non-vanilla orders (such as shown in FIG. 16A) to form a complete set because K will be too large for the non-vanilla orders to be able to generate a combination where the coefficients c3-c8 are also K. Instead, vanilla orders will primarily be matched by offsetting vanilla orders. For example, orders with c10≧K will primarily be matched with orders with c10≦−K. In other words, orders for vanilla options will be fulfilled primarily by matching buy and sell orders.

The settlement method for vanilla options can be different from that for non-vanilla orders. The price calculated represents the price of the option. It is the amount that the buyer of the option pays to the seller in return for the option. If the option pays off, the seller will have to pay some money to the buyer after the option matures. For example, in FIG. 16B, if the underlying variable x ends up at 15500, then the vanilla option will be $500 in the money, which the seller will pay to the buyer after the option matures. In the case of non-vanilla options, the auction organizer can hold money as a custodian for all auction participants and then redistribute this money as appropriate. The auction organizer does not take any risk in this case due to the formation of complete sets. This is not the case for vanilla options since there is an additional credit risk that the seller will not pay. This credit risk typically is borne either by the buyer or by the auction organizer. It can be reduced by requiring the seller to post money as partial security for his option.

The examples of FIGS. 12-16 were introduced in the context of the auction settlement approach described previously. However, the decomposition of native contracts into combination orders of basic units and auction settlement based on the combination orders is not limited to this particular approach for auction settlement. It is equally applicable to other auction settlement approaches, including for example, the approaches described in U.S. patent application Ser. No. 10/600,888, “Settlement of Auctions Using Complete Sets and Separate Price and Quantity Determination,” filed Jun. 20, 2003.

FIG. 11 is a block diagram of a system suitable for use with the present invention. Generally speaking, market participants 1110A-C and the auction organizer 1150 participate in the auction 1130 via a network 1120. The market participants 1110 enter their orders and receive updates about the auction via the network 1120. The auction organizer 1150 can also receive updates about the auction 1130 and can control the auction via the network 1120. In one specific embodiment, the network 1120 is the Internet, and the auction 1130 is hosted on a server 1132, with information stored on a database 1134. The market participants 1110 and the organizer 1150 access the Internet, typically by browsers such as Microsoft's Internet Explorer. The market participants can be individuals, but they can also include other entities, such as automatic trading programs. The server 1132 responds to requests from market participants 1110 and the organizer 1150.

It should be noted that FIG. 11 is simplified for clarity. For example, the roles of market participants 1110 and auction organizer 1150 can be implemented in a distributed fashion and/or divided among many different entities. The auction 1130 itself may also be distributed for redundancy and/or performance reasons. The server 1132 can contain different components, for example a fill module to determine 710 the fill, a price setting module to set 750 the ASPs, and an interface module to interface with outside entities (such as updates of stock prices, if relevant). Multiple servers, databases, load balancers, etc. can be used to implement the auction 1130.

As further clarification, the invention may be used with systems other than the Internet. For example, the various entities may communicate with each other over separate communications networks or dedicated communications channels, rather than through the common network 1120 of FIG. 11. Alternately, various parts of the system may be implemented by mobile components and may not be permanently attached to a communications network. For example, the different entities may interact via a wireless connection.

In alternate embodiments, the invention is implemented in computer hardware, firmware, software, and/or combinations thereof. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits) and other forms of hardware.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents. Furthermore, no element, component or method step is intended to be dedicated to the public regardless of whether the element, component or method step is explicitly recited in the claims.

What is claimed is:

1. A method for settling orders, wherein the orders are limited to a finite number of types of native contracts, comprising:
selecting a set of basic units;
expressing the orders for the native contracts as combination orders of the selected basic units; and
settling the combination orders.

2. The method of claim 1 wherein the step of settling the combination orders comprises:
forming complete sets from the combination orders.

3. The method of claim 2 wherein the basic units are selected so they can form a complete set in only one way.

4. The method of claim 1 wherein the selected basic units are efficient with respect to the finite number of native contracts.

5. A method for settling a pool of bets placed on an outcome of an event, wherein the types of bets are pre-defined, the method comprising:
selecting a set of basic units, wherein the set of basic units can support all of the pre-defined types of bets;
expressing the native bets as combination orders of the selected basic units; and
settling the combination orders.

6. The method of claim 5 wherein the pre-defined bets are not mutually exclusive but the selected basic units are mutually exclusive.

7. The method of claim 5 wherein payoffs for the bets depend only on a finite number of possible outcomes for the event, and the selected basic units include discrete contracts corresponding to the possible outcomes where the discrete contracts have a same notional.

8. The method of claim 5 wherein the event is a race and payoffs for at least some of the bets are based at least in part on a finish order for the race.

9. The method of claim 8 wherein payoffs for all of the bets are based solely on a finish order for the race.

10. The method of claim 8 wherein payoffs for all of the bets are based solely on a top N finishers for the race.

11. The method of claim 10 wherein the set of basic units consists of discrete contracts for all possible combinations of the top N finishers for the race and the discrete contracts have a same notional.

12. The method of claim 8 wherein the selected basic units are mutually exclusive and collectively exhaustive, are efficient with respect to the pre-defined types of bets and can form a complete set in only one way.

13. The method of claim 5 wherein the event is a competition between competitors and payoffs for at least some of the bets are based at least in part on scoring by competitors during the competition.

14. The method of claim 13 wherein the selected basic units are efficient with respect to the pre-defined types of bets.

15. The method of claim 13 wherein the selected basic units have one structure for low scoring and a different structure for high scoring.

16. The method of claim 13 wherein the set of basic units consists of discrete contracts for different possible scoring outcomes and the discrete contracts have a same notional.

17. The method of claim 13 wherein a total number of selected basic units is less than a total number of possible combinations of the pre-defined bets.

18. The method of claim 13 wherein the selected basic units are mutually exclusive and collectively exhaustive, are efficient with respect to the pre-defined types of bets and can form a complete set in only one way.

19. The method of claim 13 wherein a payoff for at least one pre-defined type of bet depends solely on which competitor wins the competition and a payoff for at least one other pre-defined type of bet depends solely on a mathematical attribute of a final score of the competition.

20. A method for settling native orders in an auction pool, wherein at least one of the native orders is a vanilla option and all native orders for vanilla options have strike prices in a range between a lowest strike price P₁ and a highest strike price Pₕ, the method comprising:
selecting a set of basic units, the set comprising:
at least one basic unit that is entirely within the range P₁/Pₕ and has a notional N, and
either (a) a diverging slope basic unit that has the notional N and a range of Pₕ/Pₕ+KN where KN is large; or (b) a converging slope basic unit that has the notional N and a range of P₁−KN/P₁ where KN is large;
expressing the native orders as combination orders of the selected basic units, wherein the combination orders for native vanilla call orders include at least K units of the diverging slope basic unit or the combination orders for native vanilla put orders include at least K units of the converging slope basic unit; and
settling the combination orders.

21. The method of claim 20 wherein the set of basic units consists of:
a converging slope basic unit that has a notional N and a range of P₁−KN/P₁ where KN is large;
a diverging slope basic unit that has the notional N and a range of Pₕ/Pₕ+KN;
a converging slope basic unit that has the notional N and a range of Pₕ/Pₕ+KN; and
a plurality converging slope and diverging slope basic units in the range P₁/Pₕ, all of which have the notional N.

22. The method of claim 20 wherein all of the diverging slope basic units in the range P₁/Pₕ have a slope of +1 and all of the converging slope basic units in the range P₁/Pₕ have a slope of −1.

23. The method of claim 20 wherein K is large enough that combination orders for native vanilla orders will not combine with combination orders for native non-vanilla orders to form a complete set.

24. The method of claim 20 wherein the step of settling the combination orders comprises:
matching orders to buy and sell vanilla options.

25. A computer-readable storage medium storing instructions that when executed by a computer cause the computer to perform a method for settling orders, wherein the orders are limited to a finite number of types of native contracts, the method comprising
expressing the orders for the native contracts as combination orders of pre-selected basic units; and
settling the combination orders.

26. The computer-readable storage medium of claim 25 wherein the step of settling the combination orders comprises:
forming complete sets from the combination orders.

27. The computer-readable storage medium of claim 26 wherein the pre-selected basic units can form a complete set in only one way.

28. The computer-readable storage medium of claim 25 wherein the pre-selected basic units are efficient with respect to the finite number of native contracts.

29. A computer-readable storage medium storing instructions that when executed by a computer cause the computer to perform a method for settling a pool of bets placed on an outcome of an event, wherein the types of native bets are pre-defined, the method comprising:
expressing the native bets as combination orders of pre-selected basic units, wherein the pre-selected basic units can support all of the pre-defined types of native bets; and
settling the combination orders.

30. The computer-readable storage medium of claim 29 wherein the pre-defined bets are not mutually exclusive but the pre-selected basic units are mutually exclusive.

31. The computer-readable storage medium of claim 29 wherein the event is a race and payoffs for at least some of the bets are based at least in part on a finish order for the race.

32. The computer-readable storage medium of claim 31 wherein payoffs for all of the bets are based solely on a finish order for the race.

33. The computer-readable storage medium of claim 31 wherein the pre-selected basic units are mutually exclusive and collectively exhaustive, are efficient with respect to the pre-defined types of native bets and can form a complete set in only one way.

34. The computer-readable storage medium of claim 29 wherein the event is a competition between competitors and payoffs for at least some of the bets are based at least in part on scoring by competitors during the competition.

35. The computer-readable storage medium of claim 34 wherein the pre-selected basic units are efficient with respect to the pre-defined types of native bets.

36. The computer-readable storage medium of claim 34 wherein the pre-selected basic units have one structure for low scoring and a different structure for high scoring.

37. The computer-readable storage medium of claim 34 wherein the pre-selected basic units are mutually exclusive and collectively exhaustive, are efficient with respect to the pre-defined types of bets and can form a complete set in only one way.

38. A computer-readable storage medium storing instructions that when executed by a computer cause the computer to perform a method for settling native orders in an auction pool, wherein at least one of the native orders is a vanilla option and all native orders for vanilla options have strike prices in a range between a lowest strike price P₁ and a highest strike price Pₕ, the method comprising:
expressing the native orders as combination orders of basic units drawn from a pre-selected set of basic units, wherein:
the pre-selected set of basic units comprise at least one basic unit that is entirely within the range P₁/Pₕ and has a notional N, and either (a) a diverging slope basic unit that has the notional N and a range of Pₕ/Pₕ+KN where KN is large; or (b) a converging slope basic unit that has the notional N and a range of P₁−KN/P₁ where KN is large; and
the combination orders for native vanilla call orders include at least K units of the diverging slope basic unit or the combination orders for native vanilla put orders include at least K units of the converging slope basic unit; and
settling the combination orders.

39. The computer-readable storage medium of claim 38 wherein the pre-selected set of basic units consists of:
a converging slope basic unit that has a notional N and a range of P₁−KN/P₁ where KN is large;
a diverging slope basic unit that has the notional N and a range of Pₕ/Pₕ+KN;
a converging slope basic unit that has the notional N and a range of Pₕ/Pₕ+KN; and
a plurality converging slope and diverging slope basic units in the range P₁/Pₕ, all of which have the notional N.

40. The computer-readable storage medium of claim 38 wherein all of the diverging slope basic units in the range P₁/Pₕ have a slope of +1 and all of the converging slope basic units in the range P₁/Pₕ have a slope of −1.

41. The computer-readable storage medium of claim 38 wherein K is large enough that combination orders for native vanilla orders will not combine with combination orders for native non-vanilla orders to form a complete set.

42. The computer-readable storage medium of claim 38 wherein the step of settling the combination orders comprises:
matching orders to buy and sell vanilla options.
